(19) United States
(12) Patent Application Publication
(10) Pub. No.: US 2012/0033242 A1
(43) Pub. Date: Feb. 9, 2012

(54) PRINTING PRESS CENTRAL CONTROL UNIT

(75) Inventors: Rudolf NAEGELE, Friedberg (DE); Guenther GLAS, Stadtbergen (DE)

(73) Assignee: Manroland AG, Offenbach/Main (DE)

(21) Appl. No.: 13/204,186

(22) Filed: Aug. 5, 2011

(30) Foreign Application Priority Data
Aug. 7, 2010 (DE) 10 2010 033 740.4

(51) Int. Cl. G06K 15/02

(52) U.S. Cl. 358/1.13

(57) ABSTRACT

A printing press central control unit and method is disclosed. The central control unit has at least one combined display and operating unit which serves to display objects on the one hand and to enter commands and/or operators on the other hand, such that the combined display and operating unit has a multi-touch screen in combination with a display screen.

This application claims the priority of German Patent Document No. 10 2010 033 740.4, filed Aug. 7, 2010, the disclosure of which is expressly incorporated by reference herein.

### BACKGROUND AND SUMMARY OF THE INVENTION

The invention relates to a central control unit for a printing press. In addition, the invention relates to methods for display of objects and/or input of commands and/or operators on such a printing press central control unit.

German Patent Document No. DE 10 2004 053 738 A1 describes a central control unit for a printing press. This state of the art document thus discloses a printing press central control unit having a combined display and operating unit, which serves to display objects on the one hand and serves to enter commands and/or operators on the other hand. According to this state of the art document, the combined display and operating unit is formed by a projection element having a projection plane and by a monitoring element, such that the monitoring element detects a relative position between the projection element and an input element and determines the input of commands and/or operators as a function thereof.

Against this background, the object of the present invention is to create a novel printing press central control unit. According to the invention, the combined display and operating unit has a multi-touch screen in combination with a display screen. With the present invention, it is provided for the first time that a combined display and operating unit of a printing press central control unit is provided by a multi-touch screen in combination with a display screen. Such a display and operating unit permits a completely novel operation of a printing press via a printing press central control unit.

With this invention it is possible to omit separate operating elements, e.g., a keyboard, a mouse, a trackball and/or a rolling ball.

According to an advantageous refinement of the invention, the multi-touch screen has an area and/or a contour recognition device for area and/or contour recognition of objects placed on the surface of the multi-touch screen and/or objects coming in contact with the same. With such an area and/or contour recognition device, when a print product or a print product part is placed on the surface of the multi-touch screen, the format and position of the print product or the print product part are automatically ascertainable, in which case the display screen then displays, preferably automatically, operating fields and/or visualization fields, depending on the ascertained format and the ascertained position of the print product or the print product part placed on the surface of the multi-touch screen as objects, namely a number of objects, which is coordinated automatically with the format ascertained, in a position which is coordinated automatically with the ascertained position and in a function coordinated with the recognized format.

According to another advantageous refinement of the invention, an actual state on the printing process end can be visualized on the display screen in a first area, such that a corresponding available control area with an actual value corresponding to the actual state can be visualized within the control area on the display screen in a second area, and such that by touching the multi-touch screen in a surface area assigned to the actual value and by pulling a touch element starting from this surface area of the multi-touch screen into a surface area of the multi-touch screen corresponding to a target value, commands for printing press units can be generated automatically, such that the actual value tracks the target value.

The actual state of a print image of a printed print product or a print product part can preferably be visualized in the first area, such that a color space and an actual color locus in the color space of a detail of the actual state of the print image selected by an operating person by touching the multi-touch screen can be visualized in the second area.

By touching the multi-touch screen in a surface area assigned to the actual color locus and by pulling the touch element starting from this surface area into a surface area of the multi-touch screen corresponding to a target color locus, commands for printing machine units can be generated automatically such that the actual color locus automatically follows the target color locus.

According to another advantageous refinement of the invention the multi-touch screen has a pattern recognition device for recognition of patterns in an area of an object placed on the surface of the multi-touch screen or coming in contact with same. With such a pattern recognition device, when a print product or a print product part, for example, is placed on the surface of the multi-touch screen, a pattern which is printed in a side of the print product or the print product part placed on the surface of the multi-touch screen is automatically recognizable, such that commands for printing press units can be generated automatically from the recognized pattern.

Preferred refinements of the invention are derived from the following description. Exemplary embodiments of the invention are explained in greater detail on the basis of the drawings without being limited to these embodiments.

### BRIEF DESCRIPTION OF THE DRAWINGS

FIG. 1 shows a schematic view of an inventive printing press central control unit;

FIG. 2 shows a schematic view of a combined display and operating unit of an inventive printing press central control unit in a first state thereof;

FIG. 3 shows the combined display and operating unit of FIG. 1 in a second state thereof; and

FIG. 4 shows the combined display and operating unit of FIG. 1 in a third state thereof.

### DETAILED DESCRIPTION OF THE DRAWINGS

The invention relates to a printing press central control unit of a printing press, in particular a rotary printing press or sheet-fed printing press. Objects may be displayed on such a printing press central control unit, where commands as well as operators may be input to display technical printing details on the one hand and to influence technical printing details by input of commands and/or operators on the other hand.

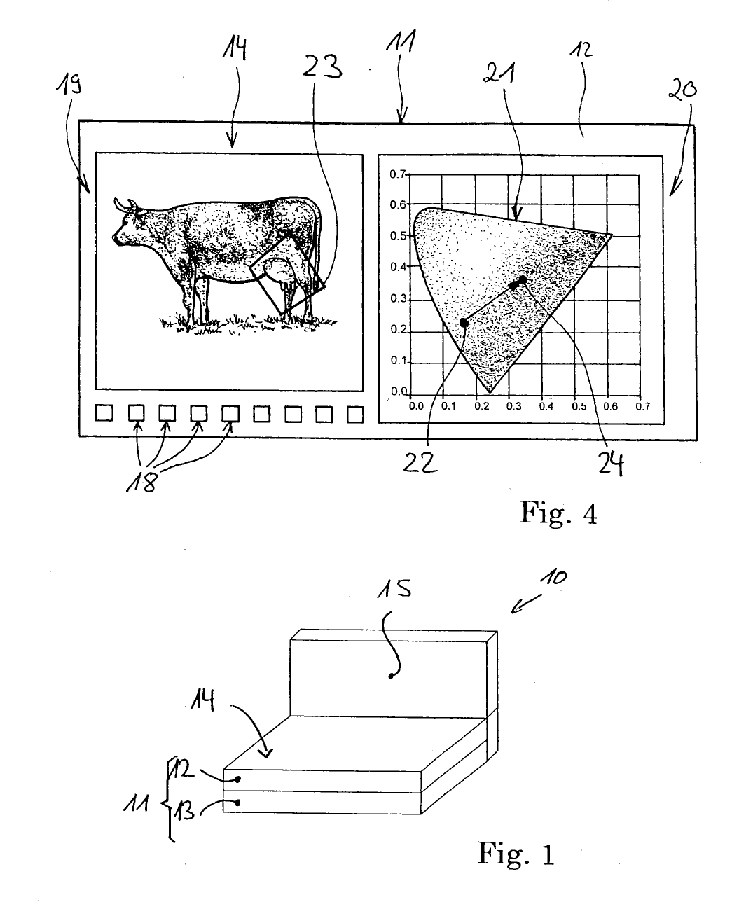

FIG. 1 shows a schematic view of a printing press central control unit 10 in the sense of the present invention, where the inventive printing press central control unit 10 comprises a combined display and operating unit 11, which serves to display objects on the one hand and to input commands and/or operators on the other hand, such that in the sense of the present invention, the combined display and operating unit 11 has a multi-touch screen 12 in combination with a display screen 13.

The multi-touch screen 12 of the combined display and operating unit 11 may be embodied as a capacitive or resistive or optical multi-touch screen 12 such that the embodiment of the same as an optical multi-touch screen is preferred.

The multi-touch screen 12 has a surface 14 which is provided by a stable and durable glass body or plastic body, for example, such that a touch and thus operation of an optical multi-touch screen 12 is monitored with the help of optical transmitters and optical receivers.

The optical sensors are preferably infrared LED devices, which are positioned either just above the surface 14 of the multi-touch screen 12 or, alternatively, are positioned in the plane of the glass body or plastic body forming the surface 14.

The optical receivers are, for example, sensors designed as cameras, which detect the light emitted by the infrared LED devices and from this infer an operation and/or touching of the surface 14 of the multi-touch screen 12.

In the case of the optical multi-touch screen 12, whose infrared LED devices are positioned just above the surface 14 of the multi-touch screen 12, the sensors are also positioned just above the surface 14 of the multi-touch screen 12. In the case of an optical multi-touch screen whose infrared LED devices are positioned in the plane of the glass body or plastic body providing the surface 14, the sensors are preferably positioned beneath a bottom side and/or rear side of the multi-touch screen.

In the sense of the present invention here, as will be explained further below in detail, it is preferred to use an optical multi-touch screen 12, whose infrared LED devices which serve as optical transmitters are positioned in the plane of the glass body and/or plastic body providing the surface 14 of the multi-touch screen 12 and emit light into it.

The display screen 13 of the combined display and operating unit 11 of the printing press central control unit 10 may be a projection screen, a transparent display screen or a non-transparent display screen, but the use of a transparent display screen is preferred.

Although the arrangement of the multi-touch screen 12 and the display screen 13 one above the other is preferred with the combined display and operating unit 11 of the inventive printing press central control unit 10, it is also possible to position the multi-touch screen and display screen of a combined display and operating unit in planes that are offset by 90° from one another, for example.

Furthermore, it is possible as shown in FIG. 1 to provide an additional display screen 15 in addition to the display screen 13 which is positioned directly beneath the multi-touch screen 12 and thus in a plane parallel to same, the additional display screen being positioned in a plane offset by approximately 90° from the multi-touch screen 12 and the display screen 13. This display screen 15 may partially take over and supplement display functions of the display screen 13.

The combined display and operating unit 11 preferably forms a so-called desktop surface of the printing press central control unit 10 or is part of a so-called desktop surface. This may be aligned horizontally and/or at an inclination.

The multi-touch screen 12 of the combined display and operating unit 11 of the inventive printing press central control unit 10 comprises, according to an advantageous refinement of the invention, an area and/or contour recognition device for recognition of areas and/or contours of objects placed on the surface 14 of the multi-touch screen 12 or touching the same.

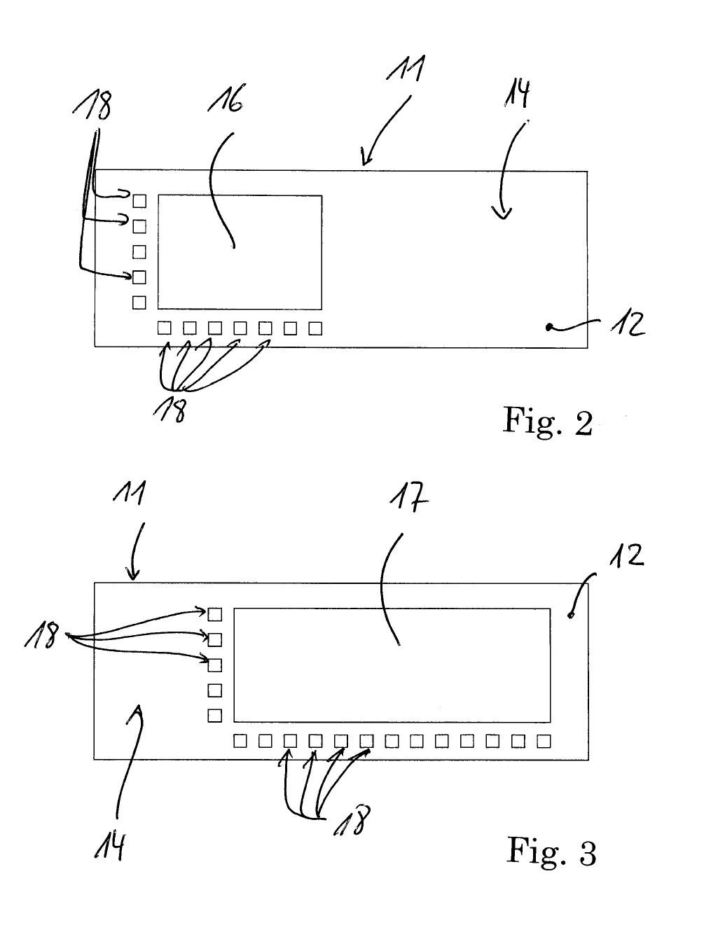

FIGS. 2 and 3 thus show a top view of the surface 14 of the multi-touch screen 12 of the combined display and operating unit 11 of the printing press central control unit 10 of FIG. 1, such that a relatively small format print product part 16 is placed on the surface 14 of the multi-touch screen 12 in FIG. 2, and a relatively large format print product part 17 of a print product printed on a printing press is placed on the surface 14 of the multi-touch screen 12 in FIG. 3. The area and/or contour recognition device automatically recognizes and/or ascertains the format of the print product part 16 and/or 17 placed on the surface 14 of the multi-touch screen 12 as well as the position of the same on the surface 14.

In this context, it is provided that the display screen 13 displays objects 18 automatically, namely operating fields and/or visualization fields, depending on the format recognized and/or ascertained by the area and/or contour recognition device and the position of the print product part 16 and/or 17 placed on the surface 14 of the multi-touch screen 12, the position being recognized and/or ascertained by the area and/or contour recognition device, such that the number of objects 18 and their position and/or their function are automatically coordinated with the recognized and/or ascertained format of the print product part 16 and/or 17.

FIG. 3 thus shows that objects 18, namely operating fields and/or visualization fields for a print product part 16 and/or 17 are always displayed directly beneath and/or directly at the site of the respective print product part 16 and/or 17 to thereby always enable an optimal positioning of the corresponding objects 18 to be displayed accordingly in relation to the print product part 16 and/or 17 regardless of the format recognized and the position of the print product 16 and/or 17 recognized on the display screen 13, which is visible through the multi-touch screen 12, and to thereby enable an optimal positioning on the multi-touch screen 12. In the case of a print product part placed obliquely on the surface, the operating and/or visualization fields would also represent the contours of the print product part obliquely.

It is thus possible, for example, that the objects 18 displayed beneath a print product part 16 and/or 17 are operating elements for ink levers and/or ink blades of inking mechanisms of the printing press, with the help of which the zonal coloration in ink zones of the print product part 16 and/or 17 can be adjusted. With this invention, it is then possible to display the corresponding objects 18 as a function of the recognized format and the recognized position of the print product part 16 and/or 17, so that the same are always assigned to the correct ink zone and the ink zone effect area influenced by the same in the print product part 16 and/or 17.

For providing this functionality of the inventive printing press central control unit 10 it is advantageous if the multi-touch screen 12 is embodied as an optical multi-touch screen whose optical transmitter embodied as infrared LED devices are not positioned just above the glass body and/or plastic body of the multi-touch screen 12 forming the surface 14 but instead are positioned at the side next to the same, so that the same objects emit light into the glass body and/or the plastic body but not above it.

Print product parts namely usually have only a minor thickness, which makes recognition of the same with optical transmitters and receivers positioned above the surface 14 of the multi-touch screen 12 impractical.

Alternatively or additionally, contours and/or surfaces of the various formats of print product parts may be displayed on the display screen 13 which can be pulled and rotated by the user into a position desired by the user on the surface 14 and to which the objects 18 are assigned in a functionally correct manner, also moving by analogy with the displacement of the formats. The operator places a print product part intended for certification on the surface formed by the contours.

Furthermore, it is possible to provide for the various formats of the print product parts to be displayed in a reduced representation at a certain location on the display screen 13 so that a selection and/or influence is made based on the current display.

With the area and/or contour recognition device of the multi-touch screen 12 it is possible to recognize and/or ascertain areas and/or contours of any objects placed on or touching the surface 14 of the multi-touch screen 12. It is thus also possible to recognize key type and/or coded areas and/or contours of objects placed on the surface and to allow the input of commands and/or operators on the printing press central control unit 10 only when the area and/or contour recognition device recognizes that an object having such a key type or coded area and/or contour has been placed on the surface 14 of the multi-touch screen 12. Unallowed access to the printing press central control unit can be prevented with simple means in this way.

Parameters of a printing process, production planning, production tracking, production analysis, a print precursor as well as all other technical equipment and/or systems of a printing company can be visualized on the combined display and operating unit 11 of the inventive printing press central control unit 10. It is likewise possible to enter commands and/or objects for all of these equipment units and/or systems on the printing press central control unit 10. It is likewise possible to display all or a subset of these equipment units and/or systems simultaneously and to make them available for operation.

Furthermore, it may be provided according to the invention that commands and/or operators or a subset of the same may be input on the printing press central control unit only when at least two surface areas of the multi-touch screen 12 are being touched simultaneously.

In this way the operating reliability of the inventive printing press central control unit can be increased because an unwanted input of commands and/or operators can be prevented.

As FIG. 4 shows, according to another advantageous refinement of the invention it is possible to display an actual state on the print side on the display screen 13 of the combined display and operating unit 11 through the transparent multi-touch screen 12 in a first area 19 such that the actual state on the print side displayed in the first area 19 in FIG. 4 is an actual state of a print image of a printed print product or a print product part, printed on a printing press. This print image displayed on the display screen in the first area 19 may also be referred to as a soft copy proof. According to this advantageous refinement of the invention, in a second area 20 of the display screen 13, an available corresponding control area having an actual value of the actual state displayed in the first area 19 may be displayed within the control area.

Thus in FIG. 4, a color space 21 and an actual color locus 22 in this color space 21 are displayed in the second area 20 of the display screen 13 and therefore are displayed through the multi-touch screen 12 for a detail 23 of the actual state of the print image shown in the first area 19, such that this detail 23 is formed by an operating person by touching, in particular by encircling and/or touching the edge of the multi-touch screen 12 in a section in which the selected detail 23 of the print image is visible on the surface 14 of the multi-touch screen 12.

By touching the multi-touch screen 12, namely the surface 14 of the same in a surface area to be assigned to the detail 23 of the print image to be selected, the actual color locus 22 of the detail 23 is thus displayed in the color space 21 available for this selected section 23 in the area 20.

By touching the surface 14 of the multi-touch screen 12 in a surface area of the same which is assigned to the actual color locus of the selected detail 23 as well as by pulling a touch element starting from this surface area of the multi-touch screen 12 up to a surface area of the multi-touch screen 12 which corresponds to a target color locus 24, commands for printing press units can be generated automatically, so that the actual color locus tracks the target color locus.

The touch element may be pulled by a finger of an operating person or a pin, so that commands for printing press units are generated automatically by this pulling of the touch element from the actual color locus and thus the actual value into a target color locus and thus a target value, for example, color values of the printing press corresponding to ink levers and/or ink blades of ink zones which influence the actual color locus of the detail 23.

Through a similar operation and/or actuation and/or touching of the surface 14 of the multi-touch screen 12 of the combined display and operating unit 11, namely by running one's finger over an edge of a surface area of the surface 14 of the multi-touch screen 12, it is possible to select printing press units visualized in this surface area, for which commands and/or operators are to be input by subsequently touching the multi-touch screen 12 in a corresponding surface area.

In the case of the printing press central control unit 10 of FIG. 1, objects to be displayed can be moved back and forth between the two display screens by pulling on a touch element, in particular by passing one's finger or a pen over the surface 14 of the multi-touch screen 12.

It is thus possible to shift an object displayed on the display screen 13 by pulling a touch element from display screen 13 onto display screen 15 in this way, so that the object is then displayed on display screen 15 and is no longer displayed on display screen 13.

The displacement of objects to be displayed between the display screens 13 and 15 may also be performed in the opposite order with the help of suitable functions in the multi-touch screen, i.e., moving the objects from display screen 15 to display screen 13.

According to another advantageous refinement of the invention, in addition to the area and/or contour recognition device, alternatively a sample recognition device may be assigned to the multi-touch screen 12 of the combined display and operating unit 11 to recognize patterns of an object placed on the surface 14 of the multi-touch screen 12. Thus, for example, it is possible to recognize a pattern printed in an object placed on the surface, namely when the object with the side and/or area having the pattern to be recognized is concealed when placed on a surface 14 of the multi-touch screen 12. In this context, it is again advantageous to use a multi-touch screen 12, whose optical transmitters designed as infrared LED devices are positioned in the plane of the surface 14 of the glass body and/or plastic body providing the surface 14 of the multi-touch screen 12.

Thus, for example, with such a pattern recognition device, when a personal identification or operating ID or other identification is placed on the surface 14 of the multi-touch screen 12, it is possible to recognize the contents or parts of the contents of the identification placed on the display screen and to automatically allow access to the inventive printing press central control unit 10 depending on the results thereof or automatically block access or to enable only partial functions for visualization and/or operation. Other key type patterns printed in an object may also be recognized.

In addition, it is possible with such a pattern recognition device to recognize patterns printed in a print product or a print product part of a print product printed on a printing machine, namely again when the print product part with the side having the pattern to be recognized is concealed when placed on the surface 14 of the multi-touch screen 12.

These patterns may be, for example, register marks which are then recognized automatically by the pattern recognition device in order to automatically compare the actual value of the register marks with corresponding set-point values and to automatically generate commands for printing press units, for example, register-adjusting devices of the printing press as a function thereof so that the actual values are brought into approximation of the set-point values.

Furthermore, it is possible to control the surface 14 of the multi-touch screen 12 as well as the display screen 13 in such a way that separate visualization masks and operating masks are made available in the same in order to be able to input simultaneously commands and/or operators via the different visualization and operating masks at the same time, for example, by multiple operating persons.

### LIST OF REFERENCE NUMBERS

10 printing press central control unit
11 combined display and operating unit
12 multi-touch screen
13 display screen
14 surface
15 display screen
16 print product part
17 print product part
18 object
19 area
20 area
21 color space
22 actual color locus
23 detail
24 target color locus

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A printing press central control unit, comprising:
a combined display and operating unit, wherein objects are displayable on the combined display and operating unit, wherein commands and/or operators are enterable on the combined display and operating unit, and wherein the combined display and operating unit includes a multi-touch screen and a display screen.

2. The printing press central control unit according to claim 1, wherein the multi-touch screen has an area and/or a contour recognition device and wherein areas and/or contours of objects placed on or touching a surface of the multi-touch screen are recognizable by the area and/or the contour recognition device.

3. The printing press central control unit according to claim 2, wherein a format of a print product or a print product part and a position of the print product or the print product part on the surface is automatically ascertainable by the area and/or the contour recognition device.

4. The printing press central control unit according to claim 3, wherein an operating field and/or a visualization field is automatically displayable by the display screen as a function of the format and position ascertained by the area and/or the contour recognition device and wherein the operating field and/or the visualization field is displayable as an object automatically coordinated with the ascertained format in a position automatically coordinated with the ascertained position and/or in a function coordinated with the ascertained format.

5. The printing press central control unit according to claim 2, wherein the commands and/or the operators are enterable only if the area and/or the contour recognition device recognizes an object having a key type area and/or a contour placed on the surface of the multi-touch screen.

6. The printing press central control unit according to claim 2, wherein all or a subset of the commands and/or the operators are enterable only when at least two surface areas of the multi-touch screen are touchable at a same time.

7. The printing press central control unit according to claim 1, wherein patterns in a surface of an object placed on or touching the surface of the multi-touch screen are recognizable by a pattern recognition device of the multi-touch screen.

8. The printing press central control unit according to claim 7, wherein the commands and/or the operators are enterable only when the object has a key type pattern.

9. The printing press central control unit according to claim 7, wherein the patterns include a printed register mark of a print product or a print product part and wherein commands for a printing press unit are automatically generatable based on the patterns.

10. The printing press central control unit according to claim 1, wherein the multi-touch screen is positioned directly above the display screen and in a plane approximately parallel to a plane of the display screen.

11. The printing press central control unit according to claim 1, further comprising a second display screen which is offset by approximately 90° to a plane of the multi-touch screen.

12. The printing press central control unit according to claim 1, wherein the display screen is directly beneath the multi-touch screen and further comprising a second display screen which is offset by approximately 90° to a plane of the multi-touch screen such that objects displayable are movable back and forth between the display screen and the second display screen by pulling a touch element along a surface of the multi-touch screen.

13. A method for operating a printing press control unit, wherein the printing press control unit includes a multi-touch screen and a display screen, comprising the steps of:
placing a print product or a print product part on a surface of the multi-touch screen;
ascertaining a format and a position of the print product or the print product part by an area and/or a contour recognition device of the multi-touch screen;
displaying one or more objects on the display screen as a function of the ascertained format and the ascertained position, wherein a quantity of the objects, a function of the objects, and a position of the objects is coordinated automatically with the ascertained format and the ascertained position.

14. A method for operating a printing press central control unit, wherein the printing press control unit includes a multi-touch screen and a display screen, comprising the steps of:
displaying an actual state of a print image of a printed print product or a print product part printed on a printing press in a first area on the display screen;
displaying an actual value corresponding to the actual state in a second area on the display device;
touching the multi-touch screen in a surface area assigned to the actual value and pulling a touch element starting from the surface area into a surface area of the multi-touch screen corresponding to a target value; and
automatically generating commands for a printing press unit based on the target value.
